(19) United States
(12) Patent Application Publication
(10) Pub. No.: US 2012/0167544 A1
(43) Pub. Date: Jul. 5, 2012

(54) Combustor with Fuel Staggering for Flame Holding Mitigation

(75) Inventors: David Kaylor Toronto, Greenville, SC (US); Kwanwoo Kim, Mason, OH (US); Abdul Rafey Khan, Greenville, SC (US); Luis Flamand, Greenville, SC (US)

(73) Assignee: GENERAL ELECTRIC COMPANY, Schnectady, NY (US)

(21) Appl. No.: 12/983,342

(22) Filed: Jan. 3, 2011

(51) Int. Cl. F02C 3/30

(52) U.S. Cl. 60/39.52

(57) ABSTRACT

The present application provides a combustor. The combustor may include an air flow path with a flow of air therein. A flow obstruction may be positioned within the air flow path and cause a wake or a recirculation zone downstream thereof. A number of fuel injectors may be positioned downstream of the flow obstruction. The fuel injectors may inject a flow of fuel into the air flow path such that the flows of fuel and air in the wake or the recirculation zone do not exceed a flammability limit.

### TECHNICAL FIELD

The present application relates generally to gas turbine engines and more particularly relates to a combustor with fuel staggering and/or fuel injector staggering for flame holding mitigation due to local flow obstructions and other types of flow disturbances.

### BACKGROUND OF THE INVENTION

In a gas turbine engine, operational efficiency generally increases as the temperature of the combustion stream increases. Higher combustion stream temperatures, however, may produce higher levels of nitrogen oxides (“NOₓ”) and other types of emissions. Such emissions may be subject to both federal and state regulation in the United States and also subject to similar regulations abroad. A balancing act thus exists between operating the gas turbine engine in an efficient temperature range while also ensuring that the output of NOₓ and other types of regulated emissions remain below the mandated levels.

Several types of known gas turbine engine designs, such as those using Dry Low NOₓ (“DLN”) combustors, generally premix the fuel flows and the air flows upstream of a reaction or a combustion zone so as to reduce NOₓ emissions via a number of premixing fuel nozzles. Such premixing tends to reduce overall combustion temperatures and, hence, NOₓ emissions and the like.

Premixing, however, may present several operational issues such as flame holding, flashback, auto-ignition, and the like. These issues may be a particular concern with the use of highly reactive fuels. For example, given an ignition source, a flame may be present in the head-end of a combustor upstream of the fuel nozzles with any significant fraction of hydrogen or other types of fuels. Any type of fuel rich pocket thus may sustain a flame and cause damage to the combustor.

Other premixing issues may be due to irregularities in the fuel flows and the air flows. For example, there are several flow obstructions that may disrupt the flow through an incoming pathway between a flow sleeve and a liner. With a combustor having fuel injector vanes that inject fuel into the airflow upstream of the head-end, these flow disturbances may create flow recirculation zones on the trailing edge of the vanes. These recirculation zones may lead to stable pockets of ignitable fuel-air mixtures that can in turn lead to flame holding or other types of combustion events given an ignition source.

There is thus a desire for an improved combustor design. Such a design should accommodate flow disturbances upstream of the fuel injectors so as to avoid flame holding, flashback, auto-ignition, and the like. Moreover, an increase in the flame holding margin may allow the use of higher reactivity fuels for improved performance and emissions.

### SUMMARY OF THE INVENTION

The present application thus provides a combustor. The combustor may include an air flow path with a flow of air therein. A flow obstruction may be positioned within the air flow path and cause a wake or a recirculation zone downstream thereof. A number of fuel injectors may be positioned downstream of the flow obstruction. The fuel injectors may inject a flow of fuel into the air flow path such that the flows of fuel and air in the wake or the recirculation zone do not exceed a flammability limit.

The present application further provides a combustor. The combustor may include an air flow path with a flow of air therein. A flow obstruction may be positioned within the air flow path and cause a wake or a recirculation zone downstream thereof. A number of fuel injectors may be positioned downstream of the flow obstruction. The fuel injectors may be positioned outside of the wake or the recirculation zone.

The present application further provides a combustor. The combustor may include an air flow path with a flow of air therein. A flow obstruction may be positioned within the air flow path and cause a wake or a recirculation zone downstream thereof. A number of fuel injectors may be positioned downstream of the flow obstruction. One or more of the fuel injectors may be downstream fuel injectors positioned downstream of but in line with the wake or the recirculation zone.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a known gas turbine engine as may be used herein.

FIG. 2 is a side cross-sectional view of a known combustor.

FIG. 3 is a partial schematic view of a combustor as may be described herein.

FIG. 4 is a partial schematic view of an alternative combustor as may be described herein.

FIG. 5 is a partial schematic view of an alternative combustor as may be described herein.

FIG. 6 is a partial schematic view of an alternative combustor as may be described herein.

### DETAILED DESCRIPTION

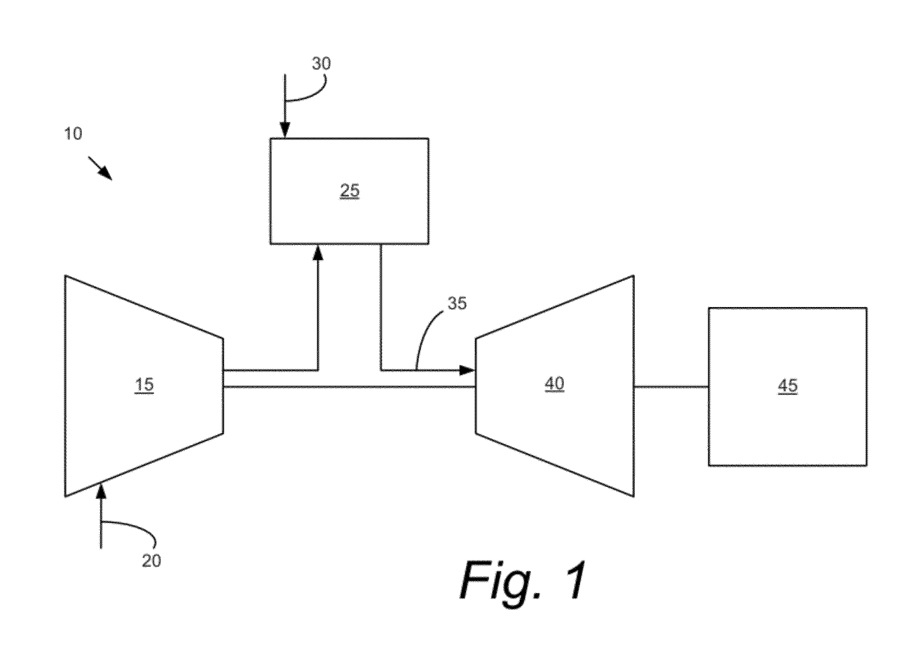

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor delivers the compressed flow of air 20 to a combustor 25. The combustor 25 mixes the compressed flow of air 20 with a compressed flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 and an external load 45 such as an electrical generator and the like.

The gas turbine engine 10 may use natural gas, various types of syngas, and/or other types of fuels. The gas turbine engine 10 may be anyone of a number of different gas turbine engines offered by General Electric Company of Schenectady, N.Y., including those such as a heavy duty 9FA gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

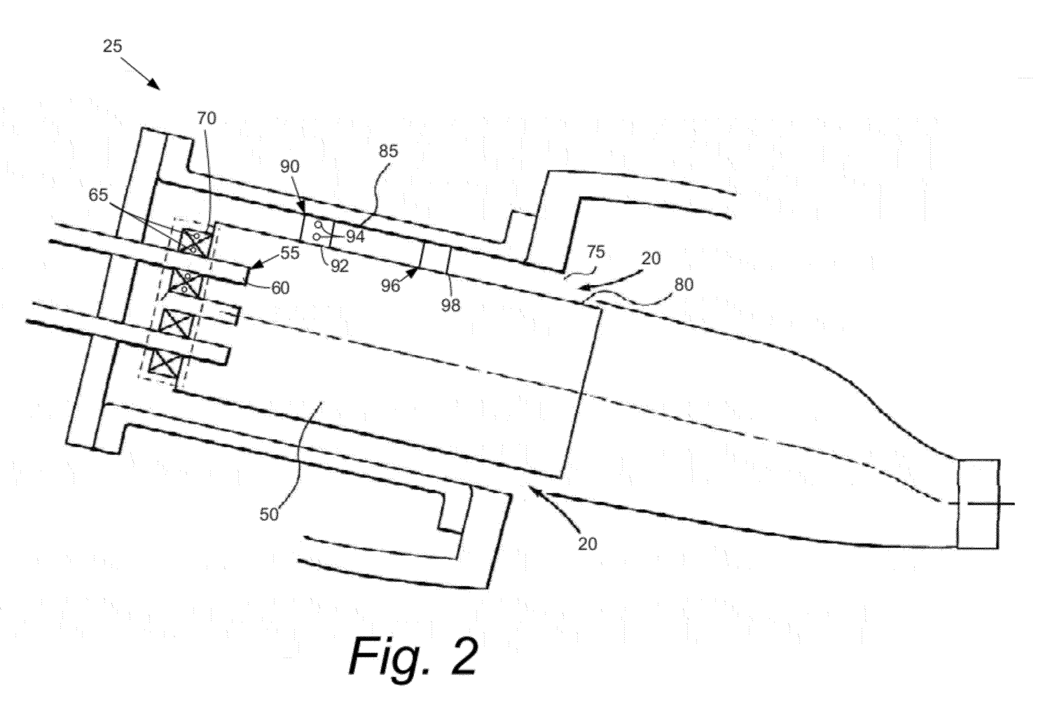

FIG. 2 shows a simplified example of a known combustor 25 that may be used with the gas turbine engine 10. Generally described, the combustor 25 may include a combustion chamber 50 with a number of fuel nozzles 55 positioned therein. Each of the fuel nozzles 55 may include a central fuel passage 60 generally for a liquid fuel. The fuel nozzles 55 also may include a number of fuel injectors 65. The fuel injectors 65 may be positioned about one or more swirlers 70. The swirlers 70 aid in the premixing of the flow of air 20 and the flows of fuel 30 therein. The fuel injectors 65 may be used with premix fuel and the like. Other types of fuels and other types of fuel circuits may be used herein.

The flow of air 20 may enter the combustor 25 from the compressor 15 via an incoming air path 75. The incoming air path 75 may be defined between a liner 80 of the combustion chamber 50 and an outer casing 85. The flow of air 20 may travel along the incoming air path 75 and then reverse direction about the fuel nozzles 55. The flow of air 20 and the flow of fuel 30 may be ignited downstream of the fuel nozzles 55 within the combustion chamber 50 such that the flow of the combustion gases 35 may be directed towards the turbine 40. Other configurations and other components may be used herein.

The combustor 25 also may have a lean pre-nozzle fuel injection system 90 positioned about the incoming air path 75 between the liner 80 and the casing 85. The lean pre-nozzle fuel injection system 90 may have a number of fuel pegs or fuel injectors 92. The fuel injectors 92 may have an aerodynamic airfoil or streamline shape. Other shapes may be used herein. The fuel injectors 92 each may have a number of injector holes 94 therein. The number and positioning of the fuel injectors 92 and the injection holes 94 may be optimized for premixing. A premix fuel or other types of fuel flows 30 may be used therein.

As described above, a number of flow obstructions 96 also may be positioned within the incoming air path 75. These flow obstructions 96 may be structures such as a number of crossfire tubes 98. Other types of obstructions 96 may include liner penetrations, liner stops, and the like. These flow obstructions 96 may create a low velocity wake or a low or negative velocity recirculation zone. The wake or the recirculation zone may envelop one or more of the fuel injectors 92 and/or create other types of local flow disturbances. A flow of the fuel 30 from the holes 94 of the fuel injectors 92 thus may be pulled upstream within the wake or recirculation zone. Although these flow obstructions 96 may cause these flow disturbances, the structures are otherwise required for efficient combustor operation.

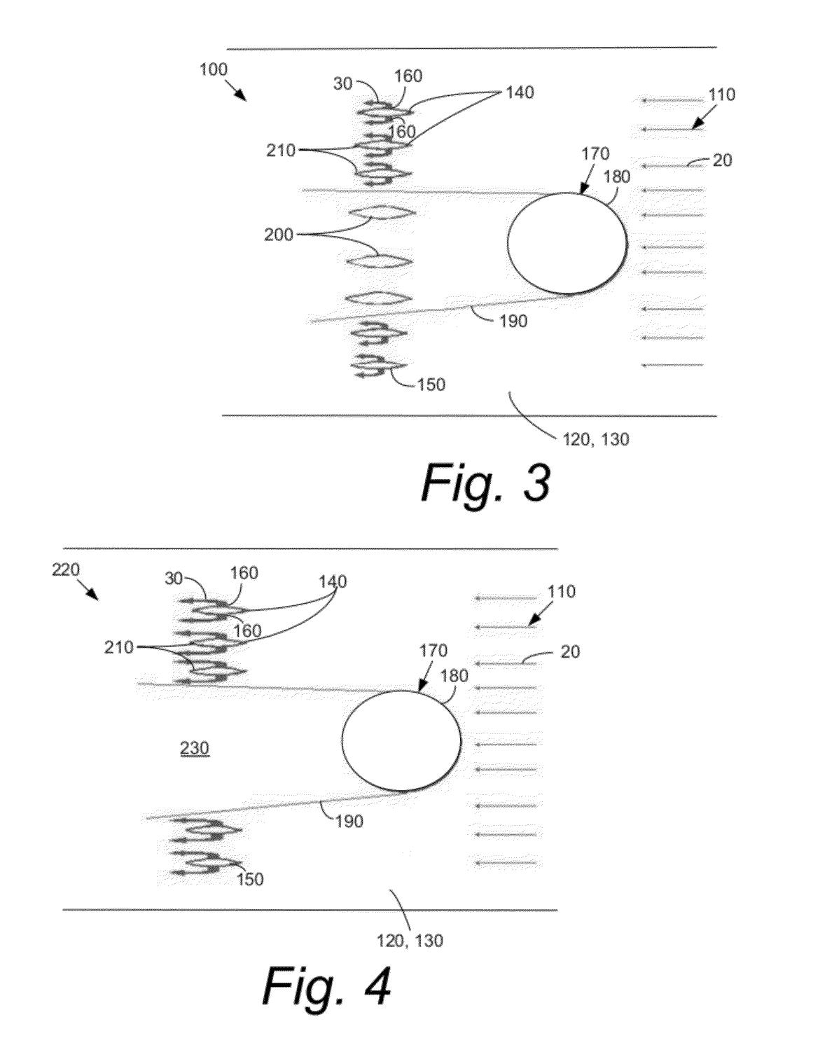

FIG. 3 shows portions of a combustor 100 as may be described herein. Specifically, an air path 110 may be configured between a liner 120 and a casing 130. The air path 110 also may be configured between other structures. The combustor 100 may include a number of fuel pegs or fuel injectors 140 positioned in the air path 110. The fuel injectors 140 likewise may have an aerodynamic airfoil or streamlined shape 150 to optimize flame holding resistance. Other shapes may be used herein. Any number of the fuel injectors 140 may be used in any size or position. The fuel injectors 140 each may have a number of injector holes 160 therein. The injector holes 160 may be on one or both sides of the fuel injectors 140. Any number of the injector holes 160 may be used in any size or position. Other configurations and other components may be used herein.

The air path 110 also may include one or more flow obstructions 170 therein. The flow obstructions 170 may be a crossfire tube 180 or any other type of flow obstruction including liner penetrations, liner stops, and the like. The flow obstruction may be any structure that may create a flow disturbance in the flow of air 20. The flow disturbance may be a wake or other type of region with a reduced or negative velocity that may serve as a wake or a recirculation zone 190 and the like.

In this example, the fuel injectors 140 may include a number of unfueled fuel injectors 200 positioned downstream of the flow obstruction 170 in the wake or the recirculation zone 190 thereof. The remaining fuel injectors 140 may be fueled fuel injectors 210. By removing the flow of fuel 30 in the fuel injectors 140 within the wake or the recirculation zone 190, the possibility of fuel entrainment therein that may lead to flashback and the like may be reduced. To the extent that the flow of fuel 30 enters the wake or the recirculation zone 190, the maximum fuel-air mixture may never exceed a flammability limit for a number of given conditions because of the unfueled fuel injectors 200 therein. A position outside or downstream or otherwise out of the wake or the recirculation zone 190 thus means that the position of the fuel injector 140 is in an acceptable velocity range with respect to an overall bulk velocity in the air path 110. Other configurations and other components may be used herein.

FIG. 4 is an alternative embodiment of a combustor 220 as may be described herein. As above, the combustor 220 includes a number of the fuel pegs or fuel injectors 140 positioned within the air path 110. In this example, there are no fuel injectors 140 positioned downstream of the wake or the recirculation zone 190 caused by the flow obstruction 170. Rather, an unobstructed path 230 may be used. The unobstructed path 230 likewise eliminates the possibility of fuel entrainment in the wake or the recirculation zone 190 by removing the flow of fuel 30 therein. To the extent that the flow of fuel 30 enters the wake or the wake or the recirculation zone 190, the maximum fuel-air mixture may never exceed a flammability limit for a number of given conditions because of the unobstructed path 230. Other configurations and other components may be used herein.

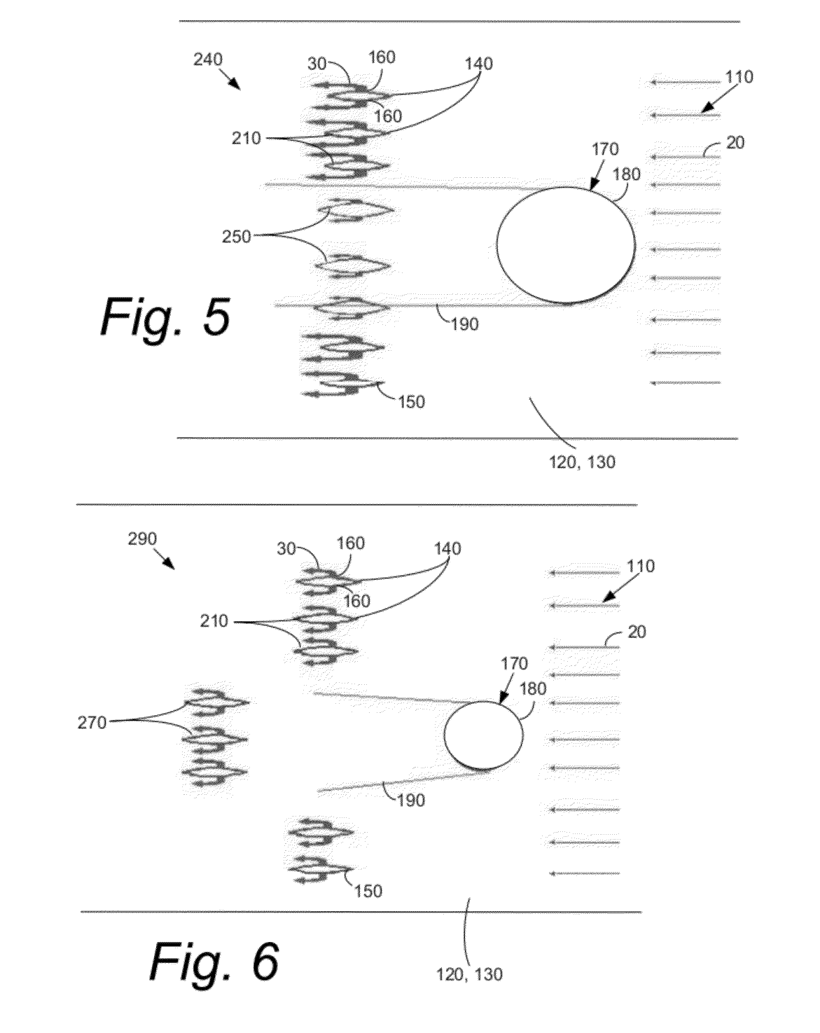

FIG. 5 shows a further embodiment of a combustor 240 as may be described herein. In this example, the combustor 240 includes a number of the fuel injectors 140 positioned within the air path 110 downstream of the flow obstruction 170. In this example, a number of reduced fuel flow fuel injectors 250 may be positioned within the wake or the recirculation zone 190. Fueled fuel injectors 210 may be positioned outside of the wake or the recirculation zone 190. Reducing the flow of fuel 30 through the reduced fuel flow fuel injectors 250 within the wake or the recirculation zone 190 thus may prevent flame holding and the like because the maximum fuel-air mixture may never exceed a flammability limit for a number of given conditions. Other configurations and other components may be used herein.

FIG. 6 shows a further example of a combustor 260 as may be described herein. The combustor 260 also may include a number of the fuel injectors 140 positioned within the pathway 110 downstream of the flow obstruction 170. In this example, the fuel injectors 140 may include a number of downstream fuel injectors 270. The downstream fuel injectors 270 may be positioned further downstream from, for example, the fueled fuel injectors 210 and downstream of the wake or the recirculation zone 190 caused by the flow obstruction 170. The downstream fuel injectors 270 also may be fueled fuel injectors 210. Removing the fuel injectors 140 and the flow of fuel 30 from the wake or the recirculation zone 190 also removes the possibility of fuel entrainment while maintaining a uniform fuel profile. To the extent that the flow of fuel 30 enters the wake or the recirculation zone 190, the maximum fuel-air mixture may never exceed a flammability limit for a number of given conditions because of the lack of fuel injectors 140 therein. Other configurations and other components may be used herein.

In use, the combustors described herein thus reduce the possibility of fuel entrainment downstream of the flow obstructions 170 so as to reduce the possibility of flame holding and other types of combustion events about the fuel injectors 140. The fuel injectors 140 may vary the fuel-air ratio that could feed a wake or a recirculation zone caused by the flow obstructions 170. The fuel injectors 140 also may have an increased flame holding margin such that the overall gas turbine engine 10 may be able to use higher reactivity fuels.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A combustor, comprising:
an air flow path with a flow of air therein;
a flow obstruction positioned within the air flow path;
the flow obstruction causing a wake or a recirculation zone downstream thereof; and
a plurality of fuel injectors positioned downstream of the flow obstruction;
wherein the plurality of fuel injectors inject a flow of fuel into the air flow path such that flows of fuel and air in the wake or the recirculation zone do not exceed a flammability limit therein.

2. The combustor of claim 1, wherein the plurality of fuel injectors comprises one or more unfueled fuel injector or injector pegs within the wake or the recirculation zone.

3. The combustor of claim 1, wherein the plurality of fuel injectors comprises a plurality of fueled fuel injectors outside of the wake or the recirculation zone.

4. The combustor of claim 1, wherein the plurality of fuel injectors comprises one or more reduced flow fuel injectors within the wake or the recirculation zone.

5. The combustor of claim 1, wherein the plurality of fuel injectors define an unobstructed path downstream of the wake or the recirculation zone.

6. The combustor of claim 1, wherein the plurality of fuel injectors comprises one or more downstream fuel injectors downstream of but in line with, the wake or the recirculation zone.

7. The combustor of claim 1, wherein the air flow path is defined by a liner and a casing.

8. The combustor of claim 1, further comprising a plurality of fuel nozzles downstream of the plurality of fuel injectors.

9. The combustor of claim 1, wherein the plurality of fuel injectors comprises an airfoil-like shape.

10. The combustor of claim 1, wherein the plurality of fuel injectors comprises a plurality of injector holes therein.

11. A combustor, comprising:
an air flow path with a flow of air therein;
a flow obstruction positioned within the air flow path;
the flow obstruction causing a wake or a recirculation zone downstream thereof; and
a plurality of fuel injectors positioned downstream of the flow obstruction;
wherein the plurality of fuel injectors are positioned outside of the wake or the recirculation zone.

12. The combustor of claim 11, wherein the plurality of fuel injectors inject a flow of fuel into the air flow path such that flows of fuel and air in the wake or the recirculation zone do not exceed a flammability limit therein.

13. The combustor of claim 11, wherein the plurality of fuel injectors comprises one or more unfurled fuel injectors or pegs within the wake or the recirculation zone.

14. The combustor of claim 11, wherein the plurality of fuel injectors define an unobstructed path downstream of the wake or the recirculation zone.

15. The combustor of claim 11, wherein the plurality of fuel injectors comprises one or more downstream fuel injectors downstream of but in line with, the wake or the recirculation zone.

16. The combustor of claim 11, wherein the air flow path is defined by a liner and a casing.

17. The combustor of claim 11, further comprising a plurality of fuel nozzles downstream of the plurality of fuel injectors.

18. The combustor of claim 11, wherein the plurality of fuel injectors comprises an airfoil-like shape.

19. A combustor, comprising:
an air flow path with a flow of air therein;
a flow obstruction positioned within the air flow path;
the flow obstruction causing a wake or a recirculation zone downstream thereof; and
a plurality of fuel injectors positioned downstream of the flow obstruction;
wherein the plurality of fuel injectors comprises one or more downstream fuel injectors positioned downstream of, but in line with, the wake or the recirculation zone.

20. The combustor of claim 19, wherein the plurality of fuel injectors inject a flow of fuel into the air flow path such that flows of fuel and air in the wake or the recirculation zone do not exceed a flammability limit therein.
